(19) United States
(12) Patent Application Publication
(10) Pub. No.: US 2010/0295663 A1
(43) Pub. Date: Nov. 25, 2010

(54) METHODS AND SYSTEMS FOR UTILIZING BACKSCATTERING TECHNIQUES IN WIRELESS APPLICATIONS

(75) Inventors: Kambiz Shoarinejad, (US); Maryam Soltan, (US)

Correspondence Address: ADELI & TOLLEN, LLP, 11940 San Vicente Blvd., Suite 100, LOS ANGELES, CA, 90049, US

(73) Assignee: Radiofy LLC, a California Limited Liability Company, Los Angeles, CA (US)

(21) Appl. No.: 12/851,537

(22) Filed: Aug. 5, 2010

Related U.S. Application Data
(62) Division of application No. 11/405,893, filed on Apr. 18, 2006.

(51) Int. Cl. H04Q 5/22

(52) U.S. Cl. 340/10.1

(57) ABSTRACT

Embodiments of the present invention include methods and systems for utilizing backscattering techniques in wireless applications. In one embodiment, the present invention includes a method of wirelessly controlling a device comprising, in a first electronic device, generating a first command, modulating the first command, and transmitting the modulated first command over a first communication channel using an RF signal. In a second electronic device, the RF signal is received over the first communication channel, and the modulated first command is demodulated and executed. In one embodiment, the second electronic device absorbs and uses at least some power from the RF signal transmitted by the first electronic device. In one embodiments, data generated by the second device may be transmitted back to the first electronic device using backscattering.

### BACKGROUND

This patent document generally relates to backscattering communications, especially methods and systems for utilizing backscattering techniques in wireless applications.

Unless otherwise indicated herein, the approaches described in this section are not necessarily all prior art to the claims in this application and are not admitted to be prior art by inclusion in this section.

Radio Frequency Identification (“RFID”) systems typically use radio frequency and backscattering techniques to identify, and track people, animals, and assets. An RFID system contains at least two components, a reader (also known as an “initiator” or an “interrogator”) and an RFID tag (target). A reader typically has its own internal power source and generates a RF carrier wave, typically a sine wave, to transmit energy to the RFID tag and retrieve information from it. A passive RFID tag does not have an internal power source and is energized when it receives the RF carrier wave from the reader. An active RFID tag, on the other hand, has an internal power source.

An RFID tag typically contains identification information, which is backscattered to the reader. “Backscattering” techniques in an RFID system generally refer to the techniques that use backscattered RF profiles to communicate information. For example, when a reader transmits information to a tag, the reader modulates data with a carrier wave and transmits the modulated signal. The tag receives and demodulates the data. A tag may communicate information with a reader by modulating the impedance of an antenna so that a carrier wave generated by the reader backscatters with a profile of the modulated tag data. The reader may then detect the backscattered signal from the tag and demodulate the data from the tag. Some examples of well-known RFID systems include book security systems in libraries and animal identification systems. In the library example, the security gates of a library serve as the reader of this RFID system. Each book in the library has an RFID tag, and each book is associated with the identification information of the tag. Accordingly, any time a book with an RFID tag passes by the security gates, the identification information of the tag backscatters to the security gates, and information associated with the tag is checked against the database of the library to ensure the book has been properly checked out.

In the exemplary systems discussed above, the tags function only to store identification information (e.g., a tag ID), and backscattering techniques are used solely to communicate the identification information of the tags to the reader. Various methods and systems to further utilize backscattering techniques in wireless application are disclosed herein.

### SUMMARY

Embodiments of the present invention include methods and systems for utilizing backscattering techniques in wireless applications. In one embodiment, the present invention includes a method of wirelessly controlling a device comprising, in a first electronic device, generating a first command, modulating the first command, and transmitting the modulated first command over a first communication channel using an RF signal. In a second electronic device, the RF signal is received over the first communication channel, and the modulated first command is demodulated and executed, wherein the second electronic device absorbs and uses at least some power from the RF signal transmitted by the first electronic device.

In one embodiment, the first command is an activation command, and the second electronic device includes a power control element, and upon execution of the first command, the power control element is activated and the second electronic device transitions from a first power state to a second power state.

In one embodiment, the second electronic device is powered off in the first power state and the second electronic device is powered on in the second power state.

In one embodiment, when the power control element is activated, the second electronic device is coupled to a power source.

In one embodiment, the power source is a battery.

In one embodiment, the power source is an AC power source.

In one embodiment, the second electronic device includes a passive backscattering circuit.

In one embodiment, the second electronic device includes an active backscattering circuit.

In one embodiment, the second electronic device includes a nonvolatile memory for storing information when the second electronic device is powered off

In one embodiment, the second electronic device is a sensor.

In one embodiment, the second electronic device is coupled to a sensor network, and the first command selectively activates one or more sensors in the network.

In one embodiment, the second electronic device is coupled to a network, and the first command activates the network.

In one embodiment, the second electronic device is coupled to a network, and the first command controls the network.

In one embodiment, the second electronic device is coupled to a network, and the second electronic device sends network information to the first electronic device using backscattering.

In one embodiment, the second electronic device is coupled to a network, and the second electronic device sends network data to the first electronic device using backscattering.

In one embodiment, the second electronic device is coupled to an electronic system, and the first command activates the electronic system.

In one embodiment, the method further comprises enabling a second communication channel in response to executing the first command.

In one embodiment, the second communication channel is between said first and second devices.

In one embodiment, the first electronic device is a wireless access point, the second electronic device is a wireless device, and the communication channel is a Bluetooth, Zigbee, Wi-Fi, Infrared, or Ultra-Wideband wireless channel.

In one embodiment, the method further comprises sending data from the first electronic device to the second electronic device over the first communication channel.

In one embodiment, the data includes configuration parameters for the second electronic device.

In one embodiment, the data includes software updates.

In one embodiment, the first command is generated automatically by a processing system.

In one embodiment, the first command is generated in response to a user input.

In one embodiment, the first electronic device is a wireless access point and the second electronic device is a mobile device.

In one embodiment, the first electronic device and the second electronic device are mobile devices.

In another embodiment, the present invention includes a method for a wireless application comprising generating output data in response to physical stimuli received by a sensing element of a first device, modulating the output data with a first RF carrier wave to generate a first modulated signal, wherein the RF carrier wave is generated by a second device and received by the first device, receiving the first modulated signal in the second device, and demodulating the first modulated signal in the second device to produce the output data.

In one embodiment, the method further comprises, before generating said first modulated signal, manipulating said output data in the first device.

In one embodiment, the first device is a passive device, and the first device is powered by energy from the RF carrier wave.

In one embodiment, the first device is an active device, and the first device uses energy from the RF carrier wave to activate a power control element for coupling a power source to the first device.

In one embodiment, the method further comprises filtering the output data in the first device.

In one embodiment, the method further comprises receiving information in the first device from the second device.

In one embodiment, the first device receives a command from the second device, and the command selectively activates particular sensors in a sensor network.

In one embodiment, the first device receives an activation command from the second device that turns on the first device.

In one embodiment, the first device receives configuration parameters from the second device.

In one embodiment, the first device receives an algorithm for processing the output data from the second device.

In one embodiment, the first device receives calibration parameters from the second device for calibrating the sensing element.

In one embodiment, the method further comprises analyzing the output data in a processing system.

In one embodiment, the method further comprises passing the output data of the first device to a processing system coupled to the second device for analysis.

In one embodiment, the method further comprises storing the output data in a database coupled to the processing system.

In one embodiment, the method further comprises storing the output data in a database.

In one embodiment, the method further comprises generating a report.

In another embodiment, the present invention includes a wireless communication method comprising modulating a command generated by a first device with a first RF carrier wave to generate a first modulated signal, transmitting the first modulated signal, receiving the first modulated signal in a second device, demodulating the first modulated signal from the first device to retrieve the command, executing the command on the second device, modulating data generated by the second device with an RF carrier wave to generate a second modulated signal, wherein the RF carrier wave is generated by the first device and received by the second device, receiving the second modulated signal in the first device, and demodulating the second modulated signal to retrieve the data generated by the second device. In one embodiment, the second device is a sensor. In one embodiment, the data is state information about the second device. In one embodiment, the method further comprises enabling a data communication channel in response to executing the command, wherein said data communication channel is between the first and second devices. In one embodiment, the method further comprises activating the second device in response to executing the command. In one embodiment, the method further comprises activating an electronic system in response to executing the command. In one embodiment, the method further comprises selectively activating one or more sensors in a sensor network in response to executing the command. In one embodiment, the method further comprises controlling the second device using the command.

The following detailed description and accompanying drawings provide a better understanding of the nature and advantages of the present invention.

### BRIEF DESCRIPTION OF THE DRAWINGS

FIG. 1 illustrates one embodiment of a backscattering system.

FIG. 2 illustrates wirelessly controlling a device using a backscattering system.

FIGS. 3A-C are example backscattering systems according to embodiments of the present invention.

FIG. 4 illustrates one embodiment of a backscattering system.

FIG. 5 illustrates one embodiment of a backscattering system.

FIG. 6 illustrates one embodiment of a backscattering system that supports a wireless sensor application.

FIG. 7 is a flow chart of one process that one embodiment of a backscattering system follows to support a wireless sensor application.

FIG. 8 illustrates one embodiment of a backscattering system that supports a wireless remote access or control application.

FIG. 9 is a flow chart of one process that one embodiment of a backscattering system follows to support a wireless remote access application.

FIG. 10 illustrates another embodiment of a backscattering system that supports a wireless remote access application between two mobile devices.

### DETAILED DESCRIPTION

Described herein are methods and systems for utilizing backscattering techniques in wireless applications. In the following description, for purposes of explanation, numerous examples and specific details are set forth in order to provide a thorough understanding of the present invention. It will be evident, however, to one skilled in the art that the present invention as defined by the claims may include some or all of the features in these examples alone or in combination with other features described below, and may further include and equivalents of the features and concepts described herein.

The general theories behind “amplitude modulation and demodulation,” “radio frequency communication” (“RF communication”), and “data encoding and decoding” are well known in the art and will not be elaborated in detail. However, throughout this disclosure, “reader” is used interchangeably with “initiator,” “interrogator,” or “master.” Similarly, a “tag” refers to both active and passive “targets” or “slaves.” “Memory” is used interchangeably with “memory module.” A mobile device broadly refers to, without limitation, a cellular phone, a smart phone, a personal digital assistant (“PDA”), a wireless email system (e.g., a BlackBerry handheld device), a notebook computer, portable electronic music device (e.g., an MP3 player), a memory stick, or any device that can be easily moved around by a person. Additionally, the controllers and processors described below may include, without limitation, microcontrollers, microprocessors, programmable logic devices, digital state machines, or equivalent elements for processing data and performing one or more of the described functions.

### System Overview

An overview of a system that utilizes backscattering techniques in wireless applications is now provided. FIG. 1 is block diagram of one embodiment of a backscattering system. Backscattering system 100 includes a first electronic device 110, including a backscattering transceiver 111, and a second electronic device 120, also including a backscattering transceiver 121. Backscattering transceivers 111 and 121 enable devices 110 and 120 to communicate over a backscattering channel 150. Embodiments of the invention may include electronic devices used in a variety of applications including mobile devices, sensors, televisions, stereos, automobile systems, remote controls, or security systems. One or both of the devices may be components of larger electronic systems, for example.

In some applications, one of the backscattering transceivers acts as an initiator and the other backscattering transceiver acts as a passive or active target. In other applications, the backscattering transceivers may operate in multiple modes (i.e., acting as both an initiator during one period of time and a target during another period of time). A “backscattering transceiver” generally refers to a circuit that is capable of receiving or transmitting, or both, data using backscattering techniques. Example backscattering circuits and techniques that may be used in the present invention are disclosed in “RFID Handbook: Fundamentals and Applications in Contactless Smart Cards and Identification,” by Klaus Finkenzeller, John Wiley & Sons; 2 edition, May 23, 2003, (ISBN: 0470844027). More specifically, “backscattering” broadly refers to the process of transmitting data using an RF carrier wave between an initiator (e.g., the reader) and a target (e.g., a tag) wherein the target may communicate with the initiator using RF reflections from the target (e.g., from the target's antenna). In some implementations, the target may absorb and use at least some power (energy) from the RF signal transmitted by the initiator. Transmission from the target to the initiator is typically accomplished by modulating the impedance of the target's antenna so that the radar signature of the target changes over time in a controlled manner. An RF signal from the initiator is backscattered from the target to the initiator, and the initiator senses the changes in the backscattered signal caused by the modulated impedance of the antenna. Accordingly, data encoded in the modulated antenna may be passed back to the initiator. In a passive target, the energy from the initiator's transmitted signal may be absorbed and used to power the modulation and potentially other functionality as described herein. Accordingly, a backscattering system will typically include an initiator backscattering circuit 111 and a target backscattering circuit 121.

Some modulation methods used in a backscattering scheme include, without limitation, frequency shift keying (“FSK”), phase shift keying (“PSK”), amplitude shift keying (“ASK”), or combinations thereof. In one FSK modulation implementation, a ‘0’ and a ‘1’ are transmitted using two frequencies, which are both derived from the frequency of an RF carrier wave. In one PSK modulation scheme, a ‘0’ and a ‘1’ are transmitted using one frequency, which is also derived from the frequency of an RF carrier wave, but with two different phases of the RF carrier wave.

Other embodiments of backscattering transceivers 111 and 121 may further include data encoders and decoders. In particular, data bit-streams can be encoded before transmission and can be decoded after demodulation. Some examples of the encoding and decoding mechanisms are, without limitation, Return to Zero (“RZ”), Non-Return to Zero (“NRZ”) Direct, Differential Biphase, Biphase-L (or Manchester), Biphase-M, or Delay Modulation (Miller Code).

In one embodiment, device 110 may be an initiator (or master) device that is used to control the state, functionality, or operation of the target (or slave) device 120 over a backscattering channel. Example applications of the present invention may include sending one or more commands to the target device over a backscattering channel. In some embodiments described below, device 120 may be completely powered down, and device 110 may send an activation command (or activating signal) to device 120 that turns the device on or off (i.e., turns the power to device 120 on or off). For example, device 120 may be completely powered off. Device 120 may include a passive backscattering circuit for receiving a carrier wave from device 110. Device 110 may absorb and use the energy (power) from the carrier wave to activate (turn on) other circuits or systems. In some embodiments, one of devices 110 or 120 may include only a backscattering transmitter, and the other device may include only a backscattering receiver. Such an embodiment may be useful if, for example, device 110 is only being used to send an activation command to device 120, for example. In other embodiments, other commands may be issued to device 120 over a backscattering channel to execute particular operations. Data may also be sent from device 110 to device 120 over the backscattering channel as described in examples below. In some embodiments, device 120 may transmit data to device 110 over the backscattering channel in response to operations carried out on device 120.

In typical master-slave systems, the slave must periodically turn itself on for a short amount of time to determine whether the master wants to initiate a communication cycle. In one embodiment, the present invention includes a low power mechanism for starting a communication channel that does not require continuous power. A master device may use a backscattering channel to send commands to the slave device, which may include an activation command. Example master-slave (initiator-target) systems may include master devices such as cell phones, PDAs, iPods or equivalent devices and headsets, earpieces, or other remote devices as the slave. The slave device may receive a command from the master to control a “switch,” for example, to turn the slave ON and OFF. As mentioned above, in one embodiment, the slave device can be completely shut down, and the master device can wake up the slave device using the backscattering channel. For example, a Bluetooth master may initiate and control communications and actions of slave devices. Slave devices may turn on and then execute commands issued by the master device. Example applications include light switches, sensors, or an access point and wireless network connection in a laptop (e.g., wireless features may turn on when a laptop is in the area of an access point after receiving signal from access point or vice versa if desirable). Other examples include a television remote control (Master) and television (Slave) or a toy remote control and a toy.

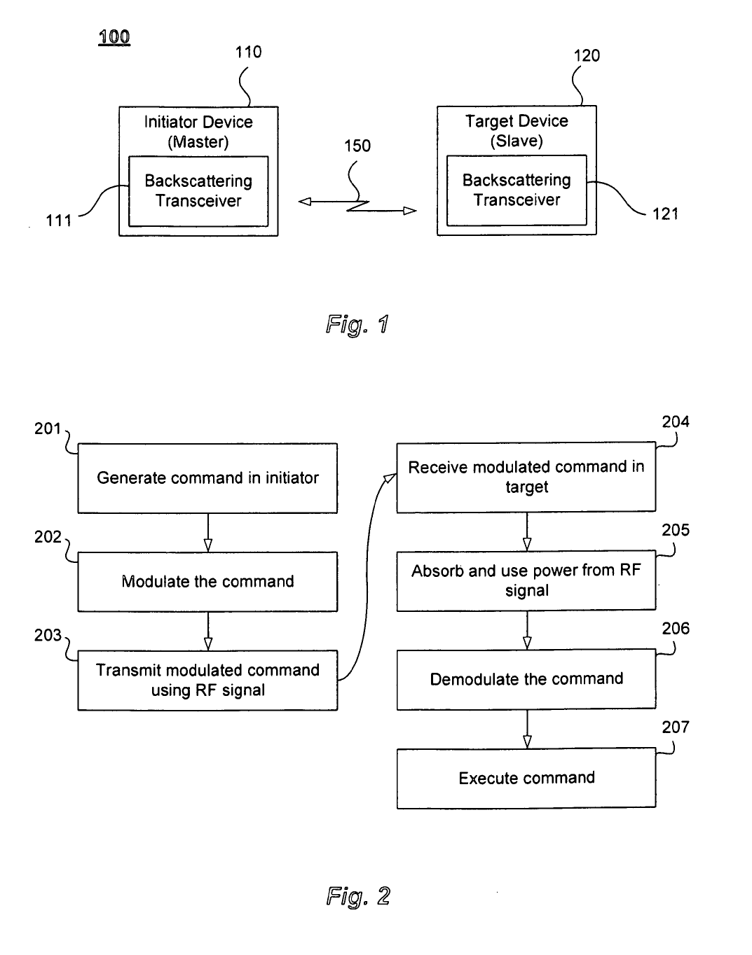

FIG. 2 illustrates wirelessly controlling a device using a backscattering system. For example, at 201 a command may be generated in the initiator device. At 202, the command is modulated. At 203, the modulated command is transmitted using an RF signal. At 204, the modulated command is received over the backscattering channel in a target device. At 205, at least some of the power from the RF signal is absorbed and used to power the target. For example, if the target is a passive device, power from the RF signal may be the only source of power available to power the target electronics. Alternatively, if the target is an active device, the target may have a local power source and may only absorb and use energy from the received RF signal to power a portion of the target's electronics to active a switch turning on the power, for example. At 206, the command is demodulated. At 207, the command is executed.

In one embodiment, the initiator device sends a power up command to the target device over a backscattering communication channel. After the target device is powered up, or after the target device powers up one or more other devices or systems connected to the target device, it may send a response back to the initiator device signaling that the power up command has been executed or that the system is powered on (i.e., a “ready” signal). In other embodiments describe in more detail below, the target device may send data generated in the target device back to the initiator device for further processing.

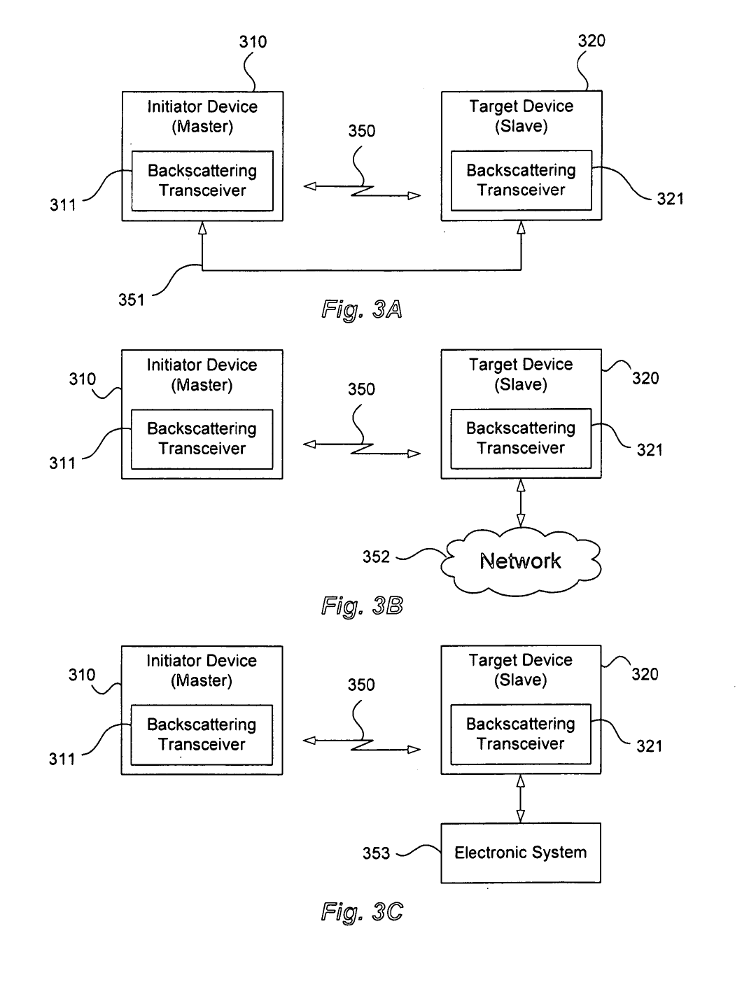

FIGS. 3A-B are examples of backscattering systems. Referring to FIG. 3A, an initiator device 310 includes a backscattering transceiver 311, and a target device 320 includes a backscattering transceiver 321. Thus, backscattering transceivers 311 and 321 allow devices 310 and 320 to communicate across backscattering channel 350. In this example, devices 310 and 320 are also coupled together over a second communication channel 351. Communication channel 351 may be based on a wired or wireless connection, for example, such as a Bluetooth, Ethernet, Zigbee, Wi-Fi, Infrared, Ultra-wideband (“UWB”), or an IEEE 802 network. In this example, one or both of the target device 320 and communication channel 351 may be initially inactive. Initiator device 310 may send an activation command over backscattering channel 350. In response to the activation command, target device 320 may turn on. Alternatively, or additionally, the activation command may activate communication channel 351.

For example, an initiator device may be part of a cell phone, and the target may be a wireless earpiece. The earpiece may initially be powered completely off to save maximum battery power. The cell phone may include a backscattering circuit that transmits an activation command to the earpiece if a user initiates a phone call or if an incoming call is detected. In response to receiving the activation command from the cell phone over the backscattering channel, the earpiece may turn on and activate a Bluetooth communication channel between the earpiece and the cell phone. Of course this is just one example application of one of the many techniques described herein that illustrates the power that may be saved by the target device because, using one embodiment of the invention, the target device may be completely powered down until the activation signal is received over the backscattering channel. In other embodiments, the initiator device may be a stationary wireless access point including a backscattering circuit that transmits a backscattering signal in a localized area. In this application a target may be a laptop computer or a mobile device (e.g., a PDA) equipped with backscattering circuits, which may receive the backscattering signal from the reader and automatically activate and/or configure a wireless communication channel with the access point.

FIG. 3B is another example of a backscattering system according to one embodiment of the present invention. In this example, device 310 sends commands to device 320 over backscattering channel 350, and device 320 executes the commands to control a network 352. Device 320 may also send network information to device 310. Example networks may include sensor networks, local area wired networks, local area wireless networks, or home entertainment networks. In one embodiment, a network may be initially turned off, and an initiator device 310 may send an activation command to target device 320 to turn the network on. Examples include automatically activated sensor networks wherein arrays of sensing elements may be selectively activated using backscattering channels. Data from the networks may be transmitted back to the initiator device for further processing and/or storage using the backscattering channel. Individual target devices may be activated controlled, and/or configured using commands and data received directly from the initiator device. Alternatively, one target device may be used to send and receive information over the backscattering channel for the network. FIG. 3C is another example of a backscattering system according to one embodiment of the present invention. In this example, commands from an initiator device 310 are transmitted across backscattering channel 350 to target device 320 to activate, control, and/or configure an electronic system 353. Information may be transmitted from device 320 to device 310, and device 310 may include, or be coupled to, a processor to process the information.

### Example Backscattering System

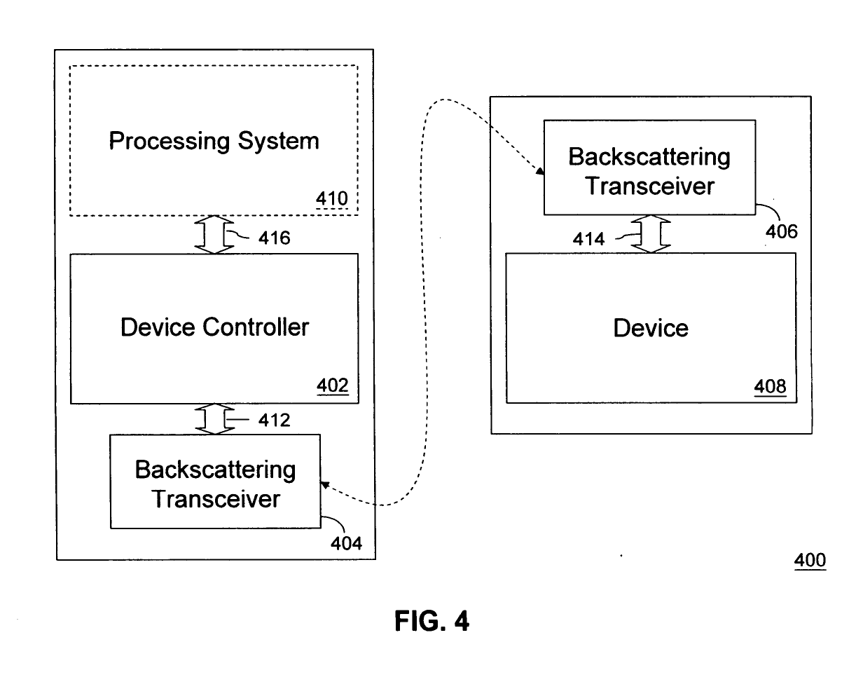

FIG. 4 is another example of a backscattering system according to one embodiment of the present invention. Backscattering system 400 includes device controller 402, which is coupled to backscattering transceiver 404 via interface 412. Backscattering system 400 further includes device 408, which is coupled to backscattering transceiver 406 via interface 414. Alternatively, backscattering transceivers 404 and 406 can be parts of (e.g., integrated on the same board or chip with) device controller 402 and device 408, respectively.

Optionally, device controller 402 is further coupled with processing system 410 via communication link 416. Communication link 416 supports techniques other than the backscattering techniques. Some examples of the techniques employed by communication link 416 include, without limitation, various versions of the Ethernet related technologies, various versions of the wireless fidelity (“Wi-Fi”) related technologies, various cellular technologies, and various internal or external bus technologies (e.g., IEEE 1394, Universal Serial Bus, and serial or parallel data transfer).

In one application, device controller 402 may be used for controlling device 408. “Control” here refers to, without limitation, activating and de-activating, monitoring, or directing device 408. In one embodiment, device 408 is controlled or managed by device controller 402.

Interfaces 412 and 414 can be, without limitation, memory mapped input/output (“I/O”) interface or I/O mapped interface. In memory mapped I/O interface, the I/O devices are addressed at certain reserved address ranges on the memory bus and can be accessed by memory transfer instructions. On the other hand, in an I/O mapped interface, specialized instructions are used to access the I/O devices. Thus, if memory mapped I/O interface is adopted, then one embodiment of device controller 402 or device 408 can respectively access backscattering transceivers 404 or 406 using the memory transfer instructions of their embedded processing units. If I/O mapped interface is adopted, then one embodiment of device controller 402 or device 408 instead respectively accesses transceiver 404 or 406 using specialized I/O instructions.

Processing system 410 may be used for analyzing, managing, or converting the data that device controller 402 receives via backscattering transceiver 404. Subsequent paragraphs will provide some examples of processing system 410.

### Example Backscattering System Supporting a Wireless Activation Application

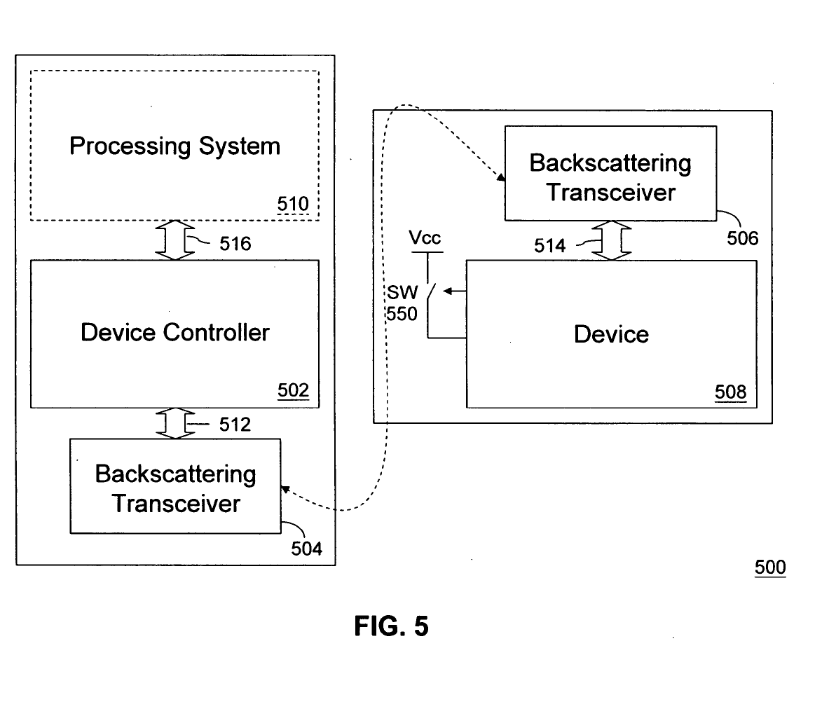

FIG. 5 is a block diagram of one embodiment of a backscattering system that supports a wireless activation application. In one embodiment, a backscattering channel is used to remotely activate a remote device or subsystems of the remote device (e.g., network connections), or both. For example, backscattering system 500 may comprise a first electronic device including device electronics 508, backscattering transceiver 506, and at least one power control element, such as switch (“SW”) 550, that couples a power supply (“Vcc”) to the device electronics. A second electronic device may include a device controller 502, backscattering transceiver 504, and optional processing system 510. Initially, device electronics 508 and backscattering transceiver 506 may be powered down. Accordingly, switch 550 is open so that Vcc is disconnected from the electronics. It is to be understood that while switch 550 is illustrated here as a single switch, in an actual implementation switch 550 may be implemented using multiple circuit elements for turning the power on and off. Furthermore, the power source may be a battery or an AC source of power coupled to the electronics (e.g., through one or more AC to DC converters and/or DC to DC converters). Device controller 502 may generate an activation command to turn on the power to device 508. Activation command generation may be a result of a direct input into device controller 502. For example, device controller 502 may be coupled to a cellular RF front end, and may generate an activation command upon detecting an incoming transmission. As another example, device controller 502 may be coupled to an input device, and may generate an activation command upon detecting a user input. For another example, device controller 502 may be embedded in a hand held remote control and used to turn on a television set using a backscattering channel when a user activates one or more inputs (e.g., pressing buttons) on the remote. As yet another example, device controller 502 may generate an activation command in response to instructions from processing system 510, which may be responsive to user inputs or system instructions.

An activation command may be modulated with a carrier wave and transmitted from backscattering transceiver 504 to backscattering transceiver 506. In one embodiment, backscattering transceiver 506 may be a passive circuit that uses the energy from the transmission to receive the modulated command, demodulate the command, and execute the command. In another embodiment, when the activation command is executed, a local power source such as Vcc (e.g., in an active target) may be coupled to some or all of the circuit elements. In one embodiment, the activation command may include control information that is used to determine which components of device 508 are to be activated. As mentioned above, components of device 508 may include device electronics or a communication channel or network between device 508 and other devices. Additionally, while the above example describes turning the power on and off, it is to be understood that the present disclosure includes using the device controller 502 to control device 508 to move between any two power consumption states (e.g., from a deep sleep mode where the majority of circuit elements are powered off to a partial or fully active mode where more or all circuit elements are activated).

### Example Backscattering System Supporting a Wireless Sensor Application

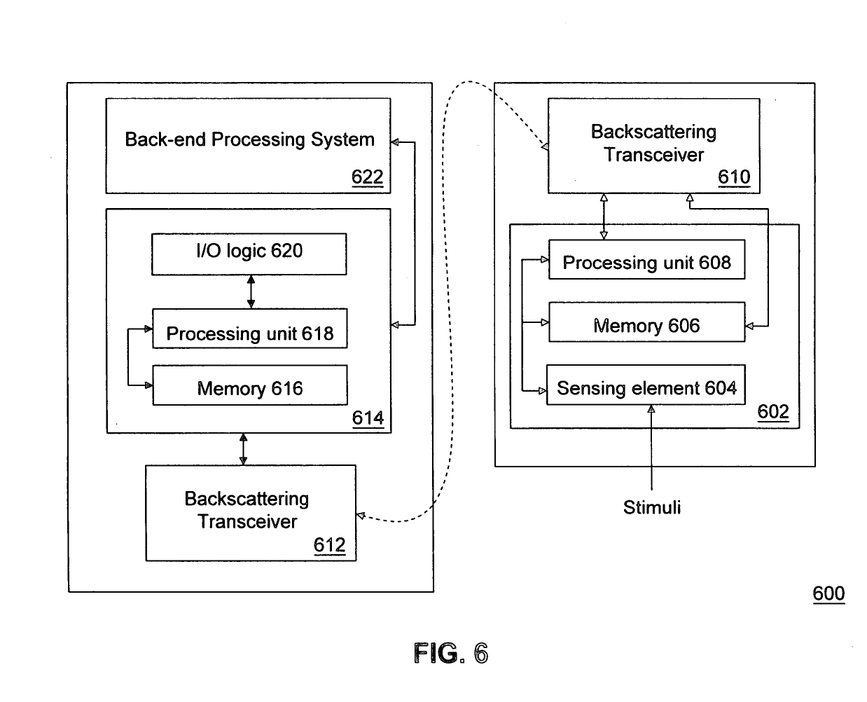

FIG. 6 is a block diagram of one embodiment of a backscattering system that supports a wireless sensor application. In one embodiment, a backscattering channel is used to remotely control, monitor, configure, and/or activate a remote device, such as a sensor or actuator, for example. For example, backscattering system 600 may include sensing device 602, backscattering transceivers 610 and 612, device controller 614, and back-end processing system 622. One embodiment of sensing device 602 further includes sensing element 604, memory 606, and processing unit 608. One embodiment of device controller 614 includes memory 616, processing unit 618, and I/O logic 620.

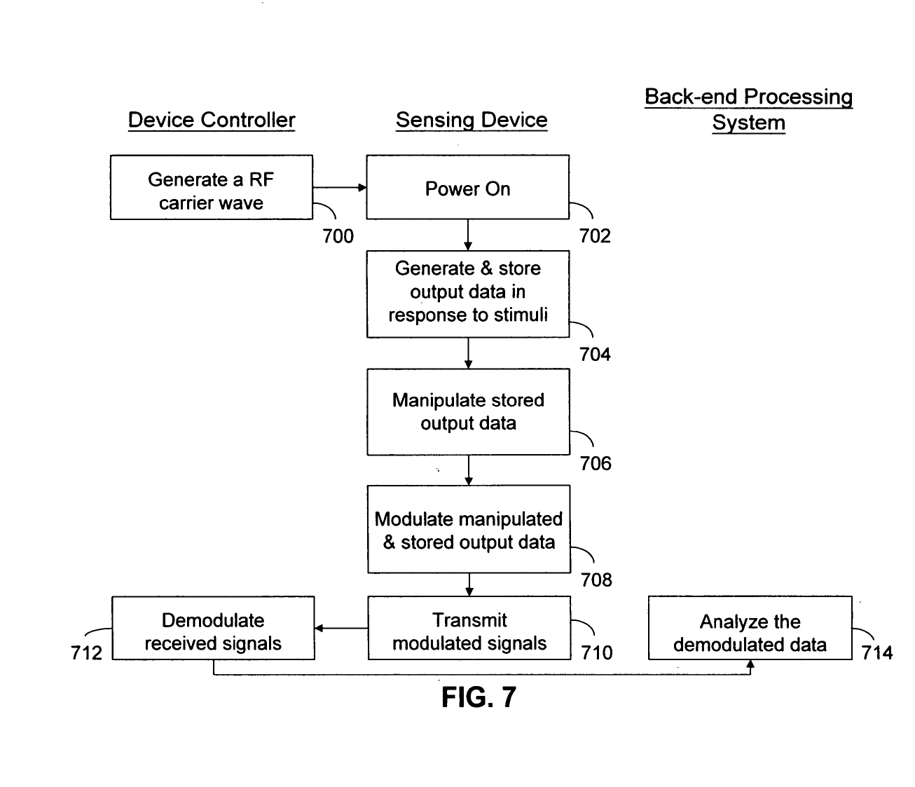

FIG. 7 is a flow chart of one example process that one embodiment of backscattering system 600 may follow to support an example wireless sensor application. Suppose sensing device 602 is a passive target in one embodiment of backscattering system 600. At 700, device controller 614 signals transceiver 612 to start generating a RF carrier wave including an activating signal, which may be triggered by 110 logic 620. For example, I/O logic 620 may receive instructions from a manual input (e.g., the press of a button on a handheld device) or a software automated system for generating an activating signal to turn on remote devices. If backscattering transceiver 610 is within the range of the RF carrier wave, it will detect the carrier wave. In a passive system, the energy from the carrier wave may be used to power up either transceiver 610 or sensor device 602, or both, at 702. In an active system, the carrier wave may be received by backscattering transceiver 610, and the activating signal may be used to control a switch to “power on” the system, or control the system to move from a sleep state to an ON state (e.g., by executing an initiation cycle). Accordingly, as mentioned above, in some applications devices may be turned from an OFF state (or power saving sleep state) to an active ON state using a backscattering channel. In one embodiment, the activation command selectively activates particular sensors in a sensor network. In this sensor example, after sensing device 602 is activated, physical stimuli may be received by sensing element 604 in sensing device 602. Sensing element 604 generates output data in response to the physical stimuli and stores the data in memory 606 at 704. The physical stimuli to a sensor can be, without limitation, temperature, light, sound, pressure, color, and motion, for example, or any other sensed input.

At 706, processing unit 608 may manipulate the stored output data from sensing element 604. For example, processing unit 608 may operate a state machine for manipulating the data. In one implementation, memory 606 contains a set of instructions, which when executed by processing unit 608, invokes the state machine. For example, in one application, processing unit 608 may filter the stored output data of the sensing element 604. For example, if sensing element 604 generates and stores output data from both light and sound stimuli, then processing unit 608 may pass only the stored output data in response to light, but not in response to sound, to backscattering transceiver 610. In another state machine, processing unit 608 filters the stored output data based on a pre-determined threshold. For example, if the stored output data are generated in response to sound stimuli, then processing unit 608 may pass only the stored output data that exceed a pre-determined decibel threshold. In yet anther state machine, processing unit 608 may pass (1) information relating to sensing device 602 (e.g., the location or the identification information of the device), which may be stored in memory 606 at the time of the installation of sensing device 602, and (2) the stored output data that result from the stimuli to backscattering transceiver 610.

At 708, backscattering transceiver 610 modulates the manipulated and stored output data. In one implementation, backscattering transceiver 610 may also encode the data before modulating them. After modulation, at 710, backscattering transceiver 610 transmits the modulated signals by reflecting back some or all of the RF signal from backscattering transceiver 612, for example, by modulating the impedance of an antenna on transceiver 610. One embodiment of backscattering transceiver 612 demodulates the modulated signals at 712 by detecting the change in the amplitude of a reflected carrier wave. At 714, back-end processing system 622 may analyze the demodulated data and perform one or more actions based on the results of the analyses. Furthermore, back-end processing system 622 may automatically store the data in a database or generate a report on the data.

In alternative embodiments of backscattering system 600, sensing device 602 can be an active target having an internal power source or a passive target without internal power. Either system can be used to remotely power up a device. If a passive target is used, the energy from the RF signal is used to initiate a power on sequence for the device. In one embodiment, device 602 is completely passive, and all data acquisition functions, processing, and communications are executed using energy from the received RF signal. In this embodiment, memory 606 may include a nonvolatile memory (e.g., using tunneling or hot electron devices) so that information may be stored and retained on the device when no power is available. If an active target is used, the RF signal triggers activation of the device using local power as described above.

In one embodiment, device controller 614 may send other types of commands or information to sensing device 602 over a backscattering channel. For example, after device 602 is turned on, it may receive additional data from controller 614. Accordingly, transceiver 612 may send commands or other information from controller 614 to transceiver 610 and device 602. Backscattering transceiver 610 receives the additional data, and processing unit 608 may process the received information and/or carry out one or more received commands. For example, device controller 614 may issue a command to reconfigure parameters of sensing device 602 or send software updates to the sensing device. Configuration parameters or software may include calibration parameters, algorithms (e.g., filtering or sensor data processing), or other executable code updates, for example.

### Example Backscattering System Supporting a Wireless Remote Access or Control Application

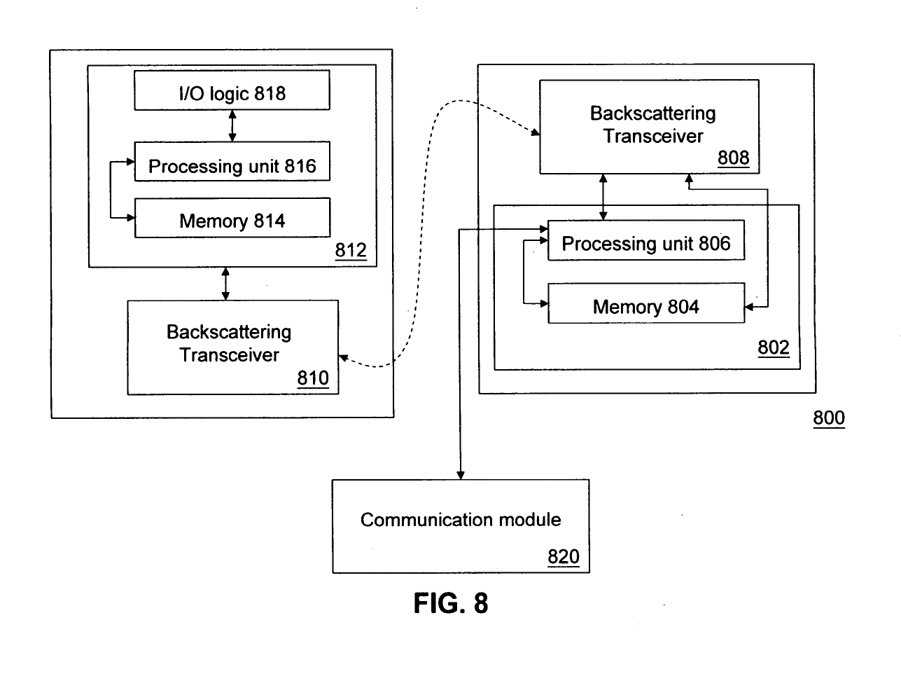

FIG. 8 is a block diagram of one embodiment of a backscattering system that supports a wireless remote access or control application. For example, one embodiment of backscattering system 800 may support power up, initialization, and/or control of communication networks using a backscattering channel. Backscattering system 800 includes a first device 812 and a second device 802. Device 802 is coupled to wireless communication module 820. In one embodiment, device controller 812 may initiate and power up a communication module 820 by issuing commands to device 802 over a backscattering channel. Communication module may activate an entire communication network, for example. For example, one embodiment of communication module 820 may support various wireless standards described above such as the different versions of the 802.11 standards.

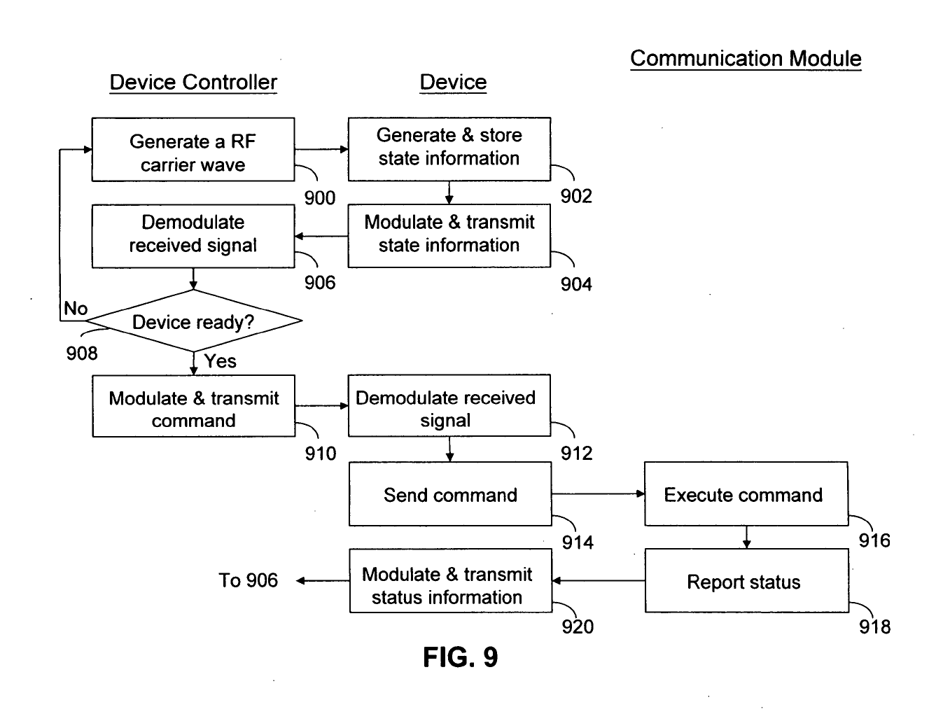

FIG. 9 is a flow chart of one process that one embodiment of backscattering system 800 may follow to support a wireless remote access or control application. Suppose device 802 is an active target in one embodiment of backscattering system 800. At 900, device controller 812 begins generating a RF carrier wave including an activating signal triggered by I/O logic 818. I/O logic may receive instructions from a manual system (e.g., the press of a button on a handheld device) or software automated system for generating an activating signal to turn on the network, for example. Backscattering transceiver 810 modulates and transmits the activating signal over the backscattering channel to device 802. Device 802 receives the activating signal, and processing unit 806 of device 802 performs a startup sequence of the network at 902, which may include conducting an internal check, initialization, and storing the current state information of device 802 in memory 804. At 904, backscattering transceiver 808 modulates and transmits the stored state information over the backscattering channel to device controller 812.

Backscattering transceiver 810 receives the modulated signal and demodulates the received signal at 906 to retrieve the state information. At 908, processing unit 816 of device controller 812 verifies whether the retrieved state information indicates that device 802 is ready to receive commands. If device 802 is ready and a state machine operated by processing unit 816 indicates a command is to be sent to communication module 820, then processing unit 816 of device controller 812 retrieves the command from memory 814 and passes it to backscattering transceiver 810. Backscattering transceiver 810 modulates and transmits the command at 910. Some examples of the commands include, without limitation, turning on and turning off communication module 820.

At 912, backscattering transceiver 808 receives the modulated signal and demodulates the received signal to retrieve the command. Then processing unit 806 of device 802 causes the command to be sent to communication module 820 at 914. Communication module 820 executes the command at 916 and then reports the status of the execution at 918 to device 802. Backscattering transceiver 808 modulates the status information of communication module 820 with the RF carrier wave from backscattering transceiver 810 and transmits the modulated signal at 920. Then the aforementioned process repeats if device controller 812 has additional commands for communication module 820.

Alternatively, one embodiment of backscattering system 800 issues commands to devices other than communication module 820. Using the same process as set forth in FIG. 9 and as discussed above, the commands issued can be, without limitation, to turn on and off a device, such as a light switch, adjust the thermostat of an air conditioning system or a refrigerator, or to adjust the volume of a stereo system, to name just a few examples.

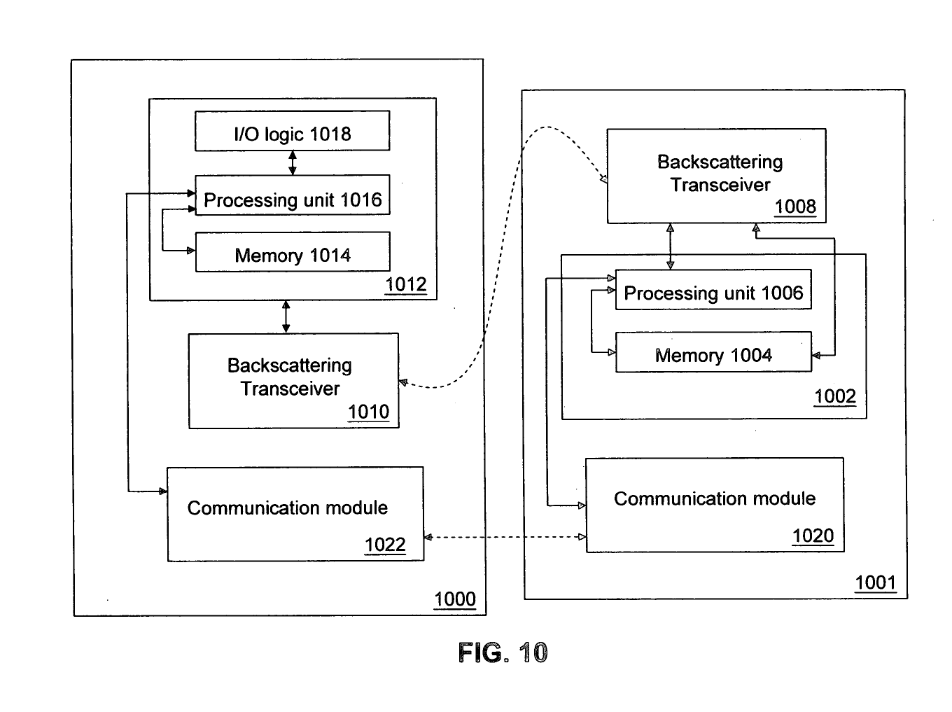

FIG. 10 is a block diagram of another embodiment of a backscattering system that supports a wireless remote access application between two systems 1000 and 1001. In this embodiment, system 1000 contains backscattering transceiver 1010 and device controller 1012 as discussed above. In addition, system 1000 also includes communication module 1022, which supports communication techniques other than the backscattering techniques. System 1001 contains backscattering transceiver 1008, device 1002, and communication module 1020 as discussed above. For example, system 1000 may be an access point that initiates and powers up a wireless device 1001 to establish a wireless communication channel so that the wireless device can access a network through the access point. For example, an access point 1000 may initiate a power up by sending a power up command between backscattering transceivers 1010 and 1008. The received signal may be used to power up device 1002 so that a processing unit 1006 issues power up and other commands to a communication module 1020 to set up the wireless channel.

Alternatively, systems 1000 and 1001 may be mobile devices, and backscattering system supports wireless remote access between two mobile devices. For illustration purposes, suppose communication modules 1022 and 1020 both support the same Wi-Fi standards and can communicate with one another. Also, suppose the power of communication module 1020 of mobile device 1001 is currently off due a period of inactivity. Suppose further User U of mobile device 1000 wishes to access certain data stored on mobile device 1001. According to the flow chart of FIG. 9, the following activities may occur:
(1) User U enables device controller 1012 by pressing a designated button on mobile device 1000 as U is physically near by mobile device 1001. The press of the button signals I/O logic 1018, which then causes processing unit 1016 to operate a state machine by executing certain instructions stored in memory 1014. Here, processing unit 1016 causes backscattering transceiver 1010 to generate a RF carrier wave including an activation command to activate device 1002 and/or module 1020;
(2) Device 1002 in mobile device 1001 indicates whether it is ready to receive commands by backscattering its current state information using the carrier wave generated by backscattering transceiver 1010 in mobile device 1000. When the state information indicates that device 1002 is ready, processing unit 1016 operates a state machine, which determines if any command, such as to turn on communication module 1020, is to be sent to device 1002. If the command is to be sent, backscattering transceiver 1010 modulates the command with a RF carrier wave that it generates and transmits the modulated signal.
(3) After communication module 1020 is turned on, and communication channel between 1020 and 1022 is established, mobile device 1000 can retrieve data stored in mobile device 1001 via a Wi-Fi communication channel established between communication modules 1022 and 1020. Moreover, after the data transfer is completed, one embodiment of processing unit 1016 may cause backscattering transceiver 1010 to modulate and transmit a command of turning off communication module 1020.

The above description illustrates various embodiments of the present invention along with examples of how aspects of the present invention may be implemented. The above examples, embodiments, and drawings should not be deemed to be the only embodiments, and are presented to illustrate the flexibility and advantages of the present invention as defined by the following claims. Based on the above disclosure and the following claims, other arrangements, embodiments, implementations, and equivalents will be evident to those skilled in the art and may be employed without departing from the spirit and scope of the invention as defined by the claims.

1-50. (canceled)

51. A method of controlling a plurality of remote devices connected to a network, the plurality of remote devices comprising a first remote device comprising a backscattering transceiver, the method comprising:
at the first remote device, receiving a command from a master device over a backscattering communication channel;
sending the command from the first remote device to one or more of said plurality of remote devices over the network;
receiving information at the first remote device from one or more of said plurality of remote devices; and
transmitting the received information from the first device to the master device over the backscattering communication channel.

52. The method of claim 51, wherein the command is an activation command that selectively powers up particular remote devices of said plurality of remote devices.

53. The method of claim 51, wherein the information from one or more of said plurality of devices includes state information requested by the master device.

54. The method of claim 51, wherein the command includes configuration data for selectively configuring particular remote devices of said plurality of remote devices.

55. The method of claim 51, wherein the plurality of remote devices comprises an electronic system, wherein each remote device is a component of the electronic system and is independently controlled through commands from the master device.

56. The method of claim 51, wherein communications within the network is through a communication channel that is one of a Bluetooth, Zigbee, Wi-Fi, Infrared, and Ultra-Wideband wireless channel.

57. A method of controlling a first device by a second device, the first and second devices each comprising a backscattering transceiver, the method comprising:
detecting an incoming transmission at the second device from a third device through a cellular radio frequency channel;
generating a modulated command at the second device in response to detecting said incoming transmission from the third device; and
transmitting the modulated command to the first device through a backscattering channel.

58. The method of claim 57, wherein the third device is a software automated system.

59. The method of claim 57, wherein the second device is a back end processing system, wherein the third device is a cellular radio frequency front end device.

60. The method of claim 57, wherein the modulated command is for configuring the first device,

61. The method of claim 57, wherein the first device includes a power control element, wherein upon the execution of the command the power control element is activated and the first device transitions from a first power state to a second power state.
